(19) United States
(12) Patent Application Publication
(10) Pub. No.: US 2016/0321913 A1
(43) Pub. Date: Nov. 3, 2016

(54) Remote Control Device for a Household Electronic Device

(71) Applicant: Kuo-Tsun Lin, Taichung City (TW)

(72) Inventor: Kuo-Tsun Lin, Taichung City (TW)

(21) Appl. No.: 14/700,370

(22) Filed: Apr. 30, 2015

(51) Int. Cl. G08C 17/02; H04W 4/00

(52) U.S. Cl. CPC G08C 17/02; H04W 4/008

(57) ABSTRACT

A remote control device for a household electronic device includes: a wireless communication module capable of wirelessly communicating with a mobile device for receiving therefrom a wireless signal, which is associated with operation of an operating module of the household electronic device so as to generate an input signal corresponding to the wireless signal; a control module generating a control signal based on the input signal from the wireless communication module; and a remote wireless module transmitting the control signal from the control module in a wireless manner such that the operating module operates in response to receipt of the control signal from the remote wireless module.

### FIELD

This disclosure relates to a control device, and more particularly to a remote control device for a household electronic device.

### BACKGROUND

A conventional handheld remote controller is manually operated to remotely control an electronic device, for example, a ceiling fan device. However, people oftentimes do not place the conventional handheld remote controller at the same spot. Therefore, the user often needs to look around for the conventional handheld remote controller, thereby resulting in inconvenience during use.

### SUMMARY

Therefore, an object of the present disclosure is to provide a remote control device that can overcome the aforesaid drawback associated with the prior art.

According to this disclosure, there is provided a remote control device for a household electronic device. The household electronic device includes a wireless reception module, and an operating module that is coupled to the wireless reception module. The remote control device of this disclosure includes a wireless communication module, a control module and a wireless transmission module.

The wireless communication module is capable of wirelessly communicating with a mobile device for receiving therefrom a wireless signal, which is associated with operation of the operating module, so as to generate an input signal corresponding to the wireless signal.

The control module is coupled to the wireless communication module for receiving the input signal therefrom, and generates a control signal based on the input signal.

The wireless transmission module is coupled to the control module, and receives the control signal from the control module so as to transmit the control signal in a wireless manner to the wireless reception module of the household electronic device, to allow the operating module of the household electronic device to operate in accordance with the control signal.

Upon receipt of the first control signal from the wireless transmission module through the wireless reception module, the operating module performs the first operation in response to the first control signal.

### BRIEF DESCRIPTION OF THE DRAWING

Other features and advantages of the present disclosure will become apparent in the following detailed description of the embodiment of this disclosure with reference to the accompanying drawing, of which:

FIG. 1 is a schematic block diagram illustrating the embodiment of a remote control device for a household electronic device according to the present disclosure.

### DETAILED DESCRIPTION

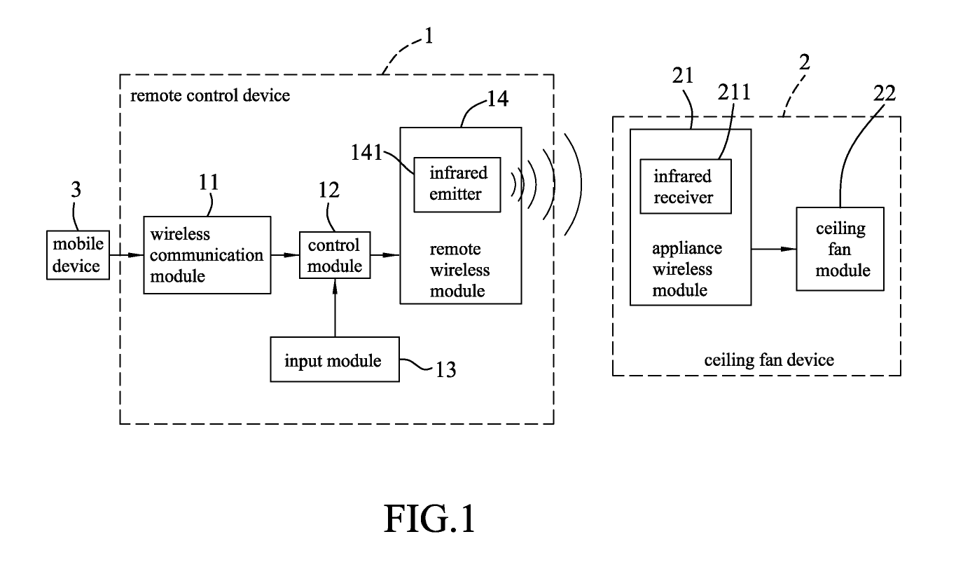

Referring to FIG. 1, the embodiment of a remote control device 1 for a household electronic device, such as a ceiling fan device 2, according to the present disclosure is adapted for use with one or more mobile devices 3 (only one is shown in FIG. 1). In this embodiment, the household electronic device (i.e., the ceiling fan device 2) includes, for example, an appliance wireless module 21, and an operating module (e.g., a ceiling fan module 22 in this embodiment) that is coupled to the appliance wireless module 21. The appliance wireless module 21 is capable of receiving wireless signals, such as optical signals and radio frequency (RF) signals. In this embodiment, the appliance wireless module 21 includes, but is not limited to, an infrared receiver 211. Optionally, the appliance wireless module 21 may also be capable of transmitting wireless signals. Each mobile device 3, such as a smart phone or a portable electronic device, is capable of performing short-distance wireless communication, such as Bluetooth and/or wireless fidelity (WiFi) communications, with the remote control device 1. The mobile device 3 is operable to transmit to the remote control device 1 a wireless signal, which is associated with operation of the ceiling fan module 22 of the ceiling fan device 2, through the wireless communication network 4. For example, each mobile device 3 may execute an application installed therein and associated with control of the ceiling fan module 22 so as to transmit the wireless signal. The remote control device 1 of this disclosure includes a wireless communication module 11, a control module 12, an input module 13 and a remote wireless module 14. It is noted that the remote control device 1 may be in the form of a handheld remote controller. Alternatively, the remote control device 1 may be fixed on, for example, a wall surface (not shown).

The wireless communication module 11 is used for establishing communication with each mobile device 3. Upon receipt of the wireless signal from one mobile device 3, the wireless communication module 11 generates a first input signal corresponding to the wireless signal. In this embodiment, the wireless communication module 11 is capable of short-distance wireless communication using Bluetooth and/or WiFi technologies. In case that the wireless communication module 11 uses Bluetooth technology, the wireless signal received by the wireless communication module 11 may have a frequency higher than 2 GHz.

The input module 13 is manually operable to generate a second input signal that is associated with the operation of the ceiling fan module 22.

The control module 12 is coupled to the wireless communication module 11 and the input module 13 for receiving respectively the first and second input signals therefrom. The control module 12 generates, in response to receipt of anyone of the first and second input signals, a corresponding control signal. It should be noted that, in use, only one of the first and second control signals may be generated at the same time.

The remote wireless module 14 is coupled to the control module 12, and is capable of receiving the control signal from the control module 12 so as to transmit the same in a known wireless manner. In this embodiment, the remote wireless module 14 includes, but is not limited to, an infrared emitter 141. Thus, the control signal transmitted by the infrared emitter 141 is an infrared signal. Optionally, the remote wireless module 14 may also be capable of receiving wireless signals. In other embodiments, the control signal transmitted by the remote wireless module 14 may be an RF signal, which may be radiated by an antenna module (not shown) and which has a frequency ranging from, for example, 300 MHz to 450 MHz. As a result, the control signal does not interfere with the wireless signal transmitted from the mobile device(s) 3 using Bluetooth communication.

In use, the remote control device 1 transmits a control signal wirelessly to the ceiling fan device 2 to control operation of the ceiling fan module 22 upon receipt of either a first input signal that is generated due to receipt thereby of a wireless input signal from the mobile device 3, or a second input signal that is generated due to user operation of the input module 13 of the remote control device 1. In other words, for a user wishing to control operation of the ceiling fan device 2, he/she may operate on his/her mobile device 3 to control the ceiling fan device 2 through communicating with the remote control device 1, or if the remote control device 1 is easily accessible, operate directly on the remote control device 1 to effect the control of the ceiling fan device 2. To sum up, due to the presence of the wireless communication module 11 capable of receiving a wireless signal associated with operation of the ceiling fan device 2, the user (s) carrying mobile device (s) 3 can also control the ceiling fan module 22 by operating the mobile device(s) 3 to transmit the wireless signal without directly operating the remote control device 1. Therefore, even if the remote control device 1 of this disclosure cannot be found by the user(s) sometimes, it can still provide the user(s) with an additional way to control the ceiling fan module 22, thereby improving convenience during use as compared to the aforesaid conventional handheld remote controller.

While the present disclosure has been described in connection with what is considered the exemplary embodiment, it is understood that this disclosure is not limited to the disclosed embodiment but is intended to cover various arrangements included within the spirit and scope of the broadest interpretation and equivalent arrangements.

1. A remote control device for a household electronic device, the household electronic device including an appliance wireless module and an operating module coupled to the appliance wireless module, said remote control device comprising:
a wireless communication module capable of wirelessly communicating with a mobile device for receiving therefrom a wireless signal, which is associated with operation of the operating module, so as to generate a first input signal corresponding to the wireless signal;
a control module coupled to said wireless communication module for receiving the first input signal therefrom, said control module generating a control signal based on the first input signal; and
a remote wireless module coupled to said control module, and receiving the control signal from said control module so as to transmit the control signal in a wireless manner to the appliance wireless module of the household electronic device, to allow the operating module of the household electronic device to operate in accordance with the control signal.

2. The remote control device as claimed in claim 1, wherein said wireless communication module is capable of short-distance wireless communication.

3. The remote control device as claimed in claim 2, wherein said wireless communication module uses Bluetooth technology to communicate.

4. The remote control device as claimed in claim 2, wherein said wireless communication module uses Wi-Fi technology to communicate.

5. The remote control device as claimed in claim 1, further comprising an input module coupled to said control module, said input module being manually operable to generate a second input signal that is associated with operation of the operating module, and outputting the second input signal to said control module;
wherein said control module further receives the second input signal from said input module, and generates a control signal based on the second input signal.

6. The remote control device as claimed in claim 2, wherein said remote wireless module includes an infrared emitter, and the control signal transmitted by said remote wireless module is an infrared signal.

7. The remote control device as claimed in claim 2, wherein the control signal transmitted by said remote wireless module is a radio frequency (RF) signal.

8. The remote control device as claimed in claim 1, wherein said wireless communication module and said remote wireless module use different communication technologies so that interference between the wireless signal received by said wireless communication module and the control signal transmitted by said remote wireless module is prevented.
